(19) United States
(12) Patent Application Publication
(10) Pub. No.: US 2014/0369384 A1
(43) Pub. Date: Dec. 18, 2014

(54) Circuit Arrangement Which is Arranged on a Substrate and Which Comprises a Temperature Monitoring System, and Method for Detecting an Excess Temperature

(71) Applicant: CONTINENTAL AUTOMOTIVE GMBH, HANNOVER (DE)

(72) Inventors: Christian Weber, Regensburg (DE); Gunther Wolfarth, Regensburg-Harting (DE)

(21) Appl. No.: 14/369,765

(22) PCT Filed: Dec. 18, 2012
(86) PCT No.: PCT/EP2012/075977

§ 371 Date: Jun. 30, 2014

(30) Foreign Application Priority Data
Dec. 29, 2011 (DE) 10 2011 090 112.4
Jan. 12, 2012 (DE) 10 2012 200 384.3

(51) Int. Cl. G01K 13/00; G01K 7/00

(52) U.S. Cl. CPC G01K 13/00; G01K 7/00
USPC 374/166

(57) ABSTRACT

A circuit arrangement disposed on a substrate, in particular integrated onto a semiconductor chip, has at least two power components which are arranged adjacent one another and which are assigned at least one temperature sensor. For a number n of power components, at least n+1 temperature sensor elements are arranged on the substrate such that each of at least n−1 temperature sensor elements has an approximately equal distance to two power components, or each of the n power components has an approximately equal distance to two temperature sensor elements. An analyzing circuit is provided in order to detect an excess temperature. The analyzing circuit analyzes at least the two temperature sensor elements lying closest to a power component with respect to an excess temperature.

The invention relates to a circuit arrangement that is arranged on a substrate, in particular a circuit arrangement that is integrated into a semiconductor chip and said circuit arrangement comprises at least two power components that are arranged adjacent to one another and at least one temperature sensor is allocated to said power components. The invention further relates to a method for identifying an over temperature in particular on a semiconductor chip.

A circuit arrangement of this type that is integrated into a semiconductor and a method of this type are disclosed in DE 197 43 253 A1. The power components that in this case are embodied as power switching elements comprise temperature sensors in their core, wherein the power switching element is switched off by means of an evaluating circuit if a predefined critical temperature is exceeded, said temperature being indicated by means of the temperature sensor. A switching-on process can only be performed if both the temperature sensor that is arranged in the core of the power switching means and also a further temperature sensor which lies at a position that is remote therefrom in the region of other temperature sensitive switching elements of the integrated circuits likewise indicate that the temperature is below the predefined temperature threshold value.

In the case of semiconductor chips on which a greater number of power components, in particular power transistors, are arranged as switching means for external loads in a restricted space, it is frequently no longer possible to place the temperature sensor elements in the interior of said power components, but rather it is necessary to arrange said temperature sensor elements adjacent to said power components. However, in the case of these power components that are arranged immediately adjacent to one another on a semiconductor chip, it is frequently no longer possible as a result of the propagation of heat, in other words as a result of the thermal cross-coupling, to achieve reliable information by means of the evaluating circuits that are likewise arranged on the semiconductor chip and this is responsible for the rise in temperature of the power components.

Similar problems can also occur in the case of discrete components that are arranged on a circuit board and are arranged immediately adjacent to one another as a result of limited space.

In principle, there is the possibility of validating the plausibility of over temperature signals from temperature sensor elements by way of the status of a power component control signal. An over temperature signal can for example be ignored if the power component is inactive. However, this method fails in the case of active power components. A further possibility for validating the plausibility is to identify an excess current situation by way of example in the case of short circuits. However, this approach often cannot be used since an over temperature can also occur despite the load current being below the excess current identification threshold.

It is therefore the object of the invention to provide a simple and yet reliable process of identifying an over temperature.

The object is achieved by means of a circuit arrangement in accordance with claim 1 and a method in accordance with claim 4. Advantageous developments are disclosed in the dependent claims.

Thus, in the case of a circuit arrangement of the generic type, in particular a circuit arrangement that is integrated into a semiconductor chip, in the case of a number of n power components at least n+1 temperature sensor elements are arranged on the semiconductor chip in such a manner that each of at least n−1 temperature sensor elements comprises an approximately identical spacing with respect to two power components, or each of the n power components comprises an approximately identical spacing with respect to in each case two temperature sensor elements, wherein an evaluating circuit is provided for the purpose of identifying an over temperature of a power component and said evaluating circuit evaluates at least the two temperature sensor elements that lie closest to the power component for an over temperature.

It is therefore always necessary for the two temperature sensor elements that lie closest to a power component to indicate an over temperature if an over temperature is to be identified as being reliably detected. In most cases, the heat is not propagated as far as a third temperature sensor, which lies clearly further away, in a sufficient amount that this also indicates an over temperature and therefore the power component that lies adjacent to the overheated power component is possibly erroneously likewise designated as generating heat and therefore switched off.

Particularly advantageous is a circuit arrangement in which the at least one n−1 temperature sensor elements are arranged between the n power components. As a consequence, the distances with respect to adjacent temperature sensor elements are clearly lower than with respect to temperature sensor elements that only lie adjacent to further power components. It is advantageous if the temperature sensor elements are arranged with an approximately identical spacing between power components; the temperature sensor elements can however also comprise different spacings with respect to the power components as long as in each case two temperature sensor elements comprise approximately identical spacing with respect to the same power component.

In a manner in accordance with the invention, an over temperature is only to be identified if at least the two temperature sensor elements that lie closest to a power component indicate an over temperature.

The invention is particularly advantageous because it is cost effective and achievable if one more temperature sensor element is provided than there are power components present. However, it goes without saying that more temperature sensors can also be provided.

The invention is to be further described hereinunder with reference to exemplary embodiments with the aid of figures.

In the figures:

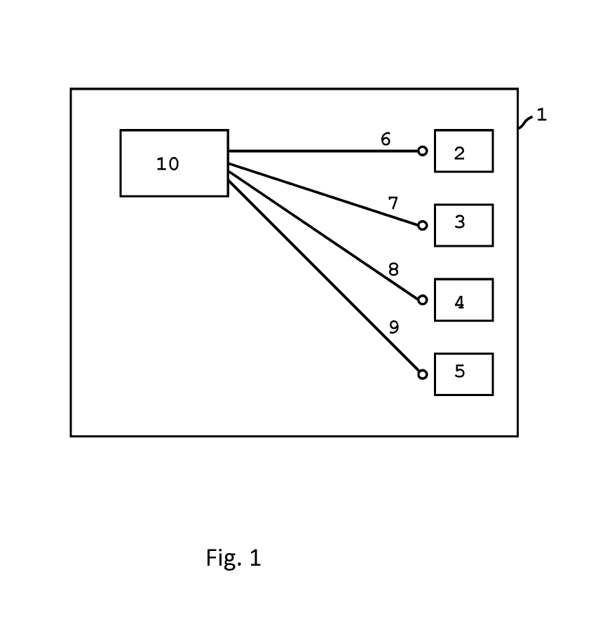

FIG. 1 illustrates a circuit arrangement on a semiconductor chip in accordance with the prior art

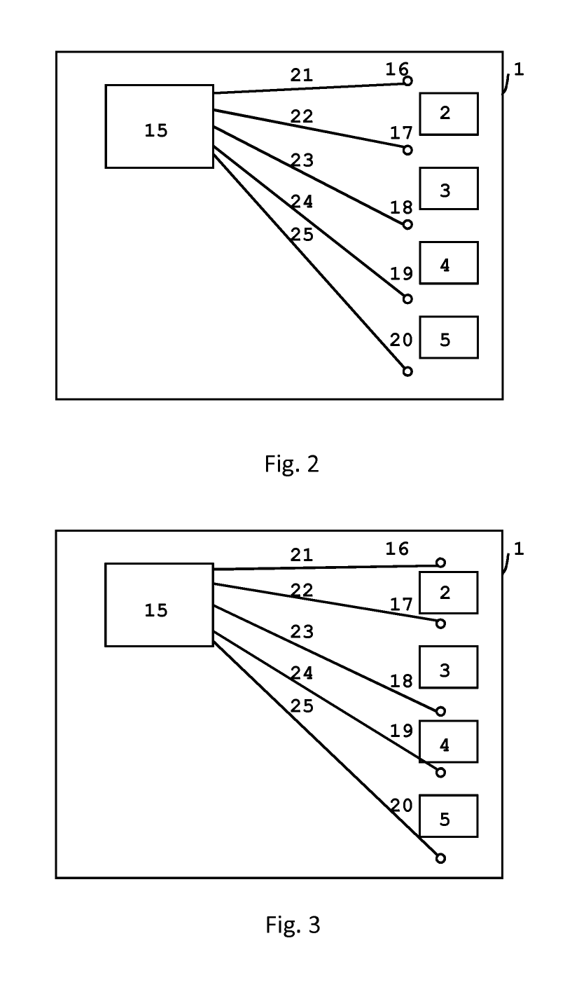

FIG. 2 illustrates a circuit arrangement in accordance with an invention in a first embodiment and

FIG. 3 illustrates a circuit arrangement in accordance with the invention in a second embodiment.

FIG. 1 illustrates a semiconductor chip 1 into which are integrated by way of example four power components 2, 3, 4, 5. The power components 2, 3, 4, 5 are allocated in each case a temperature sensor element 6, 7, 8, 9 and said temperature sensor elements are connected to an evaluating unit 10 by way of schematically illustrated lines 11, 12, 13, 14. The evaluating unit 10 determines whether the temperature that is indicated by a temperature sensor element 6, 7, 8, 9 is above a predefined threshold value and where necessary switches off the allocated power component. However, it is possible by way of example as a result of thermal cross-coupling due to the propagation of heat in the semiconductor chip for the temperature sensor 7 to indicate a temperature above its predefined threshold, although the temperature source is not in the directly adjacent power component 3 but rather in a power component 2 or 4 that lies adjacent to said power component. It is possible therefore for the power component 3 also to be switched off in an erroneous manner.

In a manner in accordance with the invention, thus in accordance with FIG. 2, the in turn four power components 2,3, 4, 5, on a semiconductor chip 1 are in this case allocated five temperature sensor elements 16, 17, 18, 19, 20 that are connected to an evaluating unit 15 by way of schematically illustrated lines 21, 22, 23, 24, 25. An over temperature is only indicated in this case if the two temperature sensor elements that lie adjacent to a power component both indicate an over temperature. If, by way of example, the power component 3 is overheated, the temperature sensor elements 17 and 18 would therefore indicate an over temperature and an evaluation of these two values would lead to the power component 3 being switched off. Since in each case only one of the two temperature sensor elements 16 and 17 or rather 18 and 19 that are allocated to the adjacent power components 2 and 4 indicates an over temperature, these power components 2 and 4 would not be detected as being overheated.

In this manner, it is possible with a high degree of reliability in a simple manner without the additional expenditure to identify and deactivate an overheating power component by means of external signals, by way of example by means of monitoring an overcurrent or output voltages.

FIG. 3 illustrates a particularly advantageous arrangement of the temperature sensor elements 16, 17, 18, 19, 20 between the power components 2, 3, 4, 5. In the case of this arrangement, the spacing with respect to the adjacent temperature sensor elements is clearly smaller than with respect to temperature sensor elements that lie further away so that a more reliable process of identifying over temperature can be performed. Furthermore, the variant is illustrated in which in each case one power component 2, 3, 4, 5 comprises approximately the identical spacing with respect to in each case two temperature sensor elements 16, 17, 18, 19, 20; however, the temperature sensor elements 16, 17, 18, 19, 20 lie centrally between the power components 2, 3, 4, 5.

The exemplary embodiments relate to embodiments on semiconductor chips where the invention can be particularly advantageously achieved. However, the invention can likewise be applied to other circuit arrangements that by way of example are mounted in a discrete manner onto a circuit board.

A process of deactivating the overheated power component element is implemented as a measure in the case of identifying an over temperature. It would, however, be similarly possible to activate a cooling process or where necessary to switch on the power component more intensely in order to reduce its power loss.

1-4. (canceled)

5. A circuit arrangement on a substrate, comprising:
a number n power components with at least two power components disposed adjacent one another on the substrate;
at least n+1 temperature sensor elements assigned to said power components;
said temperature sensor elements being arranged on said substrate such that:
each of at least n−1 temperature sensor elements are disposed at a substantially identical spacing from two respective said power components; or
each of said n power components is disposed at a substantially identical spacing from two respective said temperature sensor elements; and
an evaluating unit connected to said temperature sensor elements and configured for identifying an over-temperature, said evaluating unit evaluating at least two said temperature sensor elements lying closest to a power component for identifying an over-temperature of the respective said power component.

6. The circuit arrangement according to claim 5, wherein said at least n−1 temperature sensor elements are arranged between said n power components

7. The circuit arrangement according to claim 5, wherein said substrate is a semiconductor chip.

8. A method for identifying an over temperature in a circuit, the method comprising:
providing a circuit arrangement according to claim 5;
identifying an over-temperature only if at least the two temperature sensor elements that lie closest to a power component
indicate an over-temperature.
